(19) United States
(12) Patent Application Publication
(10) Pub. No.: US 2018/0316911 A1
(43) Pub. Date: Nov. 1, 2018

(54) INFORMATION PROCESSING APPARATUS

(71) Applicant: SONY INTERACTIVE ENTERTAINMENT INC., TOKYO (JP)

(72) Inventors: Takayuki ISHIDA, TOKYO (JP); Yasuhiro WATARI, TOKYO (JP); Akira SUZUKI, TOKYO (JP); Hiroyuki SEGAWA, KANAGAWA (JP); Hiroshi KATOH, TOKYO (JP); Tetsugo INADA, TOKYO (JP); Shinichi HONDA, SAITAMA (JP); Hidehiko OGASAWARA, TOKYO (JP)

(21) Appl. No.: 15/769,570

(22) PCT Filed: Aug. 17, 2016
(86) PCT No.: PCT/JP2016/074009

§ 371 Date: Apr. 19, 2018

(30) Foreign Application Priority Data
Nov. 17, 2015 (JP) 2015-224618

(51) Int. Cl. H04N 13/398; H04N 13/332

(52) U.S. Cl. CPC H04N 13/398; G06F 3/017; H04N 13/332

(57) ABSTRACT

This information processing apparatus allows a video display apparatus (40) worn on a head and used by a user to display a stereoscopic video including an object to be operated, and receives a gesture operation to the object by moving a hand by the user, when there is a match between a recognition position in which the user recognizes that the object is present in a real space and a shifted position deviated from a position of the hand of the user by a predetermined amount in the real space.

### TECHNICAL FIELD

The present invention relates to an information processing apparatus, an information processing method, and a program that allow a video display apparatus worn on a head and used by a user to display a stereoscopic video.

### BACKGROUND ART

In the same manner as in a head-mounted display, a video display apparatus worn on a head and used by a user has been used. In this type of video display apparatus, by a stereoscopic display, a virtual object that is not really present can be displayed as if present in front of eyes of the user. Further, this video display apparatus may be used by being combined with a technique of detecting movements of hands of the user. In accordance with such a technique, the user can move the hands and perform an operation input to a computer as if the user really touches videos displayed in front of the eyes.

### SUMMARY

### Technical Problem

When the operation input according to the above-mentioned technique is executed, the user needs to move the hands up to a particular place in the air in which videos are projected or to maintain a state in which the hands are taken up. Therefore, the execution of the operation input may be bothersome for the user and the user may get tired easily.

In view of the foregoing, it is an object of the present invention to provide an information processing apparatus, an information processing method, and a program that are capable of more easily realizing the operation input performed by moving the hands by the user to a stereoscopically displayed object.

### Solution to Problem

An information processing apparatus according to the present invention, which is an information processing apparatus connected to a video display apparatus worn on a head and used by a user, includes a video display control unit configured to allow the video display apparatus to display a stereoscopic video including an object to be operated, a specification unit configured to specify a position of a hand of the user in a real space, and an operation receiving unit configured to receive a gesture operation to the object by moving the hand by the user when there is a match between a recognition position in which the user recognizes that the object is present in the real space and a shifted position deviated from the specified position of the hand by a predetermined amount.

Also, an information processing method according to the present invention includes a step of allowing a video display apparatus worn on a head and used by a user to display a stereoscopic video including an object to be operated, a step of specifying a position of a hand of the user in a real space, and a step of receiving a gesture operation to the object by moving the hand by the user when there is a match between a recognition position in which the user recognizes that the object is present in the real space and a shifted position deviated from the specified position of the hand by a predetermined amount.

Also, a program according to the present invention causes a computer connected to a video display apparatus worn on a head and used by a user to function as a video display control unit configured to allow the video display apparatus to display a stereoscopic video including an object to be operated, a specification unit configured to specify a position of a hand of the user in a real space, and an operation receiving unit configured to receive a gesture operation to the object by moving the hand by the user when there is a match between a recognition position in which the user recognizes that the object is present in the real space and a shifted position deviated from the specified position of the hand by a predetermined amount. This program may be stored and provided in a non-transitory computer readable information storage medium.

### BRIEF DESCRIPTION OF DRAWINGS

FIG. 1 is a configuration block diagram illustrating a configuration of a video display system including an information processing apparatus according to an embodiment of the present invention.

FIG. 2 is a perspective diagram illustrating an appearance of a video display apparatus.

FIG. 3 is a functional block diagram illustrating functions of the information processing apparatus according to the present embodiment.

FIG. 4 is a diagram illustrating a method for generating a stereoscopic video including a target.

FIG. 5 is a diagram illustrating an appearance of an operation in a direct operation mode.

FIG. 6 is a diagram illustrating an example of a display image during the execution of the direct operation mode.

FIG. 7 is a diagram illustrating an appearance of an operation in an indirect operation mode.

FIG. 8 is a diagram illustrating an example of a display image during the execution of the indirect operation mode.

### DESCRIPTION OF EMBODIMENT

Hereinafter, an embodiment of the present invention will be described in detail on the basis of the accompanying drawings.

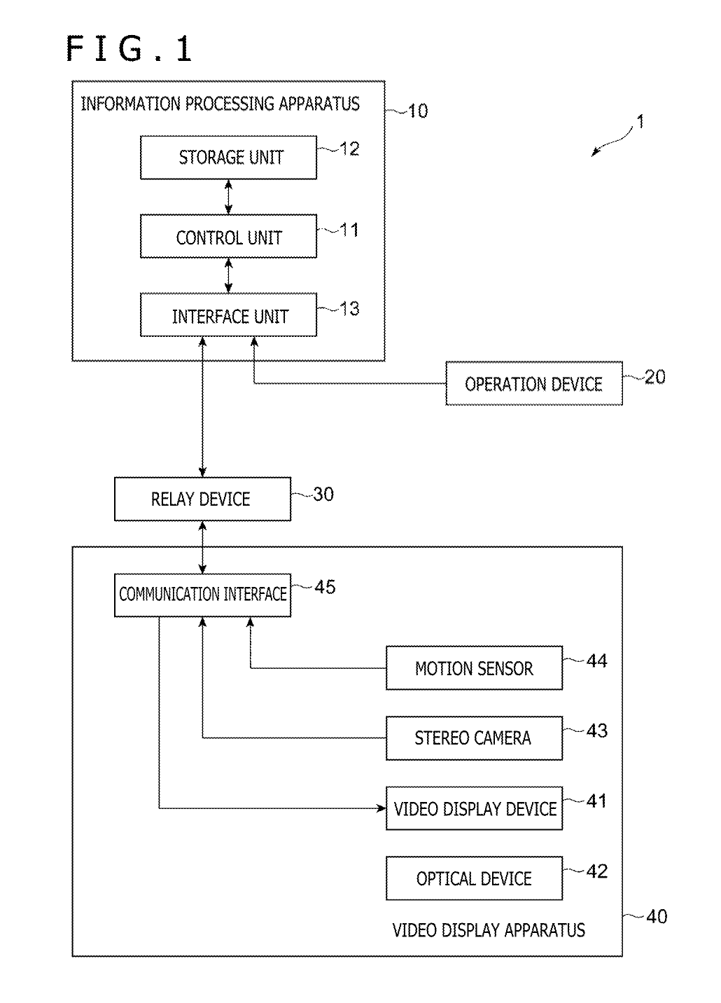

FIG. 1 is a configuration block diagram illustrating a configuration of a video display system 1 including an information processing apparatus 10 according to an embodiment of the present invention. As illustrated in the figure, the video display system 1 includes the information processing apparatus 10, an operation device 20, a relay device 30, and a video display apparatus 40.

The information processing apparatus 10 is an apparatus that supplies videos to be displayed by the video display apparatus 40 and may be, for example, a home game device, a portable game machine, a personal computer, a smartphone, a tablet, or the like. As illustrated in FIG. 1, the information processing apparatus 10 includes a control unit 11, a storage unit 12, and an interface unit 13.

The control unit 11 includes at least one processor such as a central processing unit (CPU), executes programs stored in the storage unit 12, and executes various kinds of information processing. In the present embodiment, a specific example of processing executed by the control unit 11 will be described below. The storage unit 12 includes at least one memory device such as a random access memory (RAM), and stores programs executed by the control unit 11 and data processed by such programs.

The interface unit 13 is an interface for data communication between the interface unit 13 and the relay device 30. The information processing apparatus 10 is connected to the operation device 20 and the relay device 30 via the interface unit 13 by either wire or radio. Specifically, in order to transmit videos or voices supplied by the information processing apparatus 10 to the relay device 30, the interface unit 13 may include a multimedia interface such as an High-Definition Multimedia Interface (HDMI: registered trademark). Further, the interface unit 13 includes a data communication interface such as Bluetooth (registered trademark) or a universal serial bus (USB). The information processing apparatus 10 receives various types of information from the video display apparatus 40 or transmits control signals or the like via the relay device 30 through this data communication interface. Further, the information processing apparatus 10 receives operation signals transmitted from the operation device 20 through this data communication interface.

The operation device 20 is a controller or keyboard of a home game device, or the like and receives an operation input from a user. In the present embodiment, the user can issue instructions to the information processing apparatus 10 by using two types of methods of an input operation to this operation device 20 and gesture operation to be described later.

The relay device 30 is connected to the video display apparatus 40 by either wire or radio, and receives video data supplied from the information processing apparatus 10 and outputs video signals according to the received data to the video display apparatus 40. At this time, if necessary, the relay device 30 may perform correction processing or the like for canceling distortions caused by an optical system of the video display apparatus 40 for the supplied video data and output the corrected video signals. The video signals supplied to the video display apparatus 40 from the relay device 30 include two videos of a left-eye video and a right-eye video. Also, the relay device 30 relays various types of information transmitted and received between the information processing apparatus 10 and the video display apparatus 40, such as voice data or control signals other than video data.

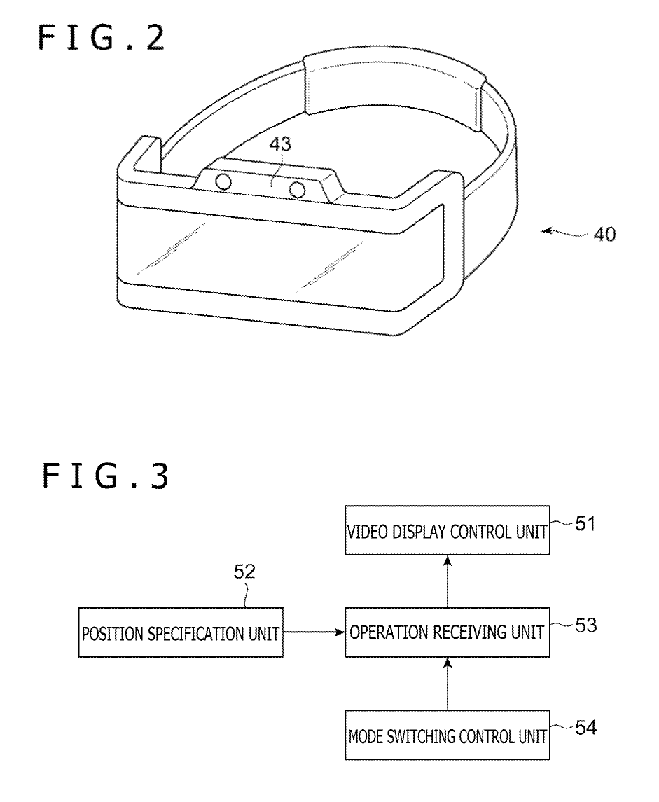

The video display apparatus 40 displays videos according to the video signals input from the relay device 30 and allows the user to browse the videos. The video display apparatus 40 is a video display apparatus worn on a head and used by the user and corresponds to browsing of videos by both eyes. Specifically, the video display apparatus 40 provides videos in front of respective eyes of a right eye and a left eye of the user. Also, the video display apparatus 40 is configured so as to display a stereoscopic video using a binocular parallax. As illustrated in FIG. 1, the video display apparatus 40 includes a video display device 41, an optical device 42, a stereo camera 43, a motion sensor 44, and a communication interface 45. Further, FIG. 2 illustrates an example of an appearance of the video display apparatus 40.

The video display device 41 is an organic electroluminescence (EL) display panel, a liquid crystal display panel, or the like and displays videos according to video signals supplied from the relay device 30. The video display device 41 displays two videos of the left-eye video and the right-eye video. In addition, the video display device 41 may be one display device displaying the left-eye video and the right-eye video side by side and may be configured of two display devices displaying the respective videos independently. Also, a heretofore known smartphone or the like may be used as the video display device 41. Also, the video display apparatus 40 may be a retina irradiation type (retina projection type) device that projects a direct video on a retina of the user. In this case, the video display device 41 may be configured of laser emitting light, a Micro Electro Mechanical Systems (MEMS) mirror scanning that light, and the like.

The optical device 42 is a hologram, a prism, a half mirror, or the like, and is disposed in front of eyes of the user, allows light of videos emitted by the video display device 41 to be transmitted or refracted, and allows the light to be incident on the respective eyes of left and right of the user. Specifically, the left-eye video displayed by the video display device 41 is made incident on the left eye of the user via the optical device 42 and the right-eye video is made incident on the right eye of the user via the optical device 42. This process permits the user to browse the left-eye video using the left eye and the right-eye video using the right eye, respectively, in the state in which the video display apparatus 40 is worn on the head. In the present embodiment, the video display apparatus 40 is assumed to be a non-transmission-type video display apparatus that is not capable of visually recognizing an appearance of the outer world through the user.

The stereo camera 43 is configured of a plurality of cameras disposed side by side along a horizontal direction of the user. As illustrated in FIG. 2, the stereo camera 43 is disposed with the front faced in the vicinity of a position of the eyes of the user. This process permits the stereo camera 43 to photograph a range near to a field of view of the user. A photographed image by the stereo camera 43 is transmitted to the information processing apparatus 10 via the relay device 30. The information processing apparatus 10 specifies a parallax of a photographic object projected in the photographed image of these plurality of cameras to thereby calculate a distance up to the photographic object. Through this process, the information processing apparatus 10 generates a distance image (depth map) expressing a distance up to each object projected in a field of view of the user. When hands of the user are projected in a photographing range of this stereo camera 43, the information processing apparatus 10 can specify positions in a real space of the hands of the user.

The motion sensor 44 measures various types of information relating to a position, a direction, and a motion of the video display apparatus 40. The motion sensor 44 may include, for example, an acceleration sensor, a gyroscope, a geomagnetic sensor, or the like. A measurement result of the motion sensor 44 is transmitted to the information processing apparatus 10 via the relay device 30. In order to specify a change in the motion or direction of the video display apparatus 40, the information processing apparatus 10 can use this measurement result of the motion sensor 44. Specifically, the information processing apparatus 10 uses the measurement result of the acceleration sensor to thereby detect a tilt or a parallel displacement to a vertical direction of the video display apparatus 40. Further, by using a measurement result of the gyroscope or the geomagnetic sensor, a rotary motion of the video display apparatus 40 can be detected. In addition, in order to detect a movement of the video display apparatus 40, the information processing apparatus 10 may use not only the measurement result of the motion sensor 44 but also the photographed image of the stereo camera 43. Specifically, a movement of the photographic object or a change in a background in the photographed image is specified to thereby specify the direction or change in the position of the video display apparatus 40.

The communication interface 45 is an interface for performing the data communication between the communication interface 45 and the relay device 30. For example, when the video display apparatus 40 performs transmission and reception of data between the video display apparatus 40 and the relay device 30 by wireless communication such as a wireless local area network (LAN) or Bluetooth, the communication interface 45 includes an antenna for communication and a communication module. Also, the communication interface 45 may include a communication interface such as an HDMI or USB for performing the data communication by wire between the communication interface 45 and the relay device 30.

Next, functions realized by the information processing apparatus 10 will be described with reference to FIG. 3. As illustrated in FIG. 3, the information processing apparatus 10 functionally includes a video display control unit 51, a position specification unit 52, an operation receiving unit 53, and a mode switching control unit 54. The control unit 11 executes a program stored in the storage unit 12, and thereby these functions are realized. This program may be provided to the information processing apparatus 10 through a communication network such as the Internet, or may be stored and provided in a computer readable information storage medium such as an optical disk.

The video display control unit 51 generates a video to be displayed by the video display apparatus 40. In the present embodiment, the video display control unit 51 generates, as a video for display, the stereoscopic video capable of a stereoscopic vision according to the parallax. Specifically, the video display control unit 51 generates, as an image for display, two images of a right-eye image and a left-eye image for the stereoscopic vision and outputs the two images to the relay device 30.

Further, in the present embodiment, the video display control unit 51 is assumed to display a video including an object to be operated by the user. Hereinafter, the object to be operated by the user is described as a target T. The video display control unit 51 determines a position of the target T in the respective right-eye image and left-eye image, for example, as if the user feels that the target T is present in front of the eyes of the user.

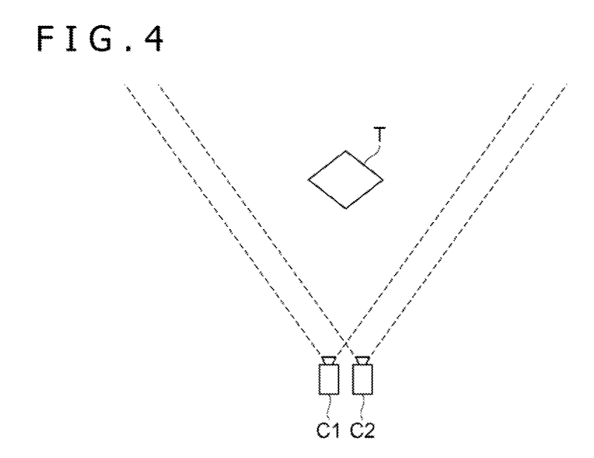

A specific example of a method for generating such an image for display will be described. The video display control unit 51 disposes the target T and two view point cameras C1 and C2 in a virtual space. FIG. 4 is a diagram illustrating such an appearance of the virtual space, and illustrates an appearance of the target T and the two view point cameras C1 and C2 viewed from above. As illustrated in the figure, the two view point cameras C1 and C2 are disposed side by side separately by a predetermined distance along the horizontal direction. In this state, the video display control unit 51 draws an image indicating an appearance of an interior portion of the virtual space viewed from the view point camera C1 and generates the left-eye video. Also, the video display control unit 51 draws an image indicating an appearance of an interior portion of the virtual space viewed from the view point camera C2 and generates the right-eye video. The video for display generated in this manner is displayed by the video display apparatus 40, and thereby the user can browse the stereoscopic video in which the user feels as if the target T is present in front of himself or herself.

An apparent position of the target T recognized by the user in the real space is determined in accordance with a relative position of the target T to the two view point cameras C1 and C2 in the virtual space. Specifically, when the target T is disposed in a position separated from the two view point cameras C1 and C2 and the image for display is generated in the virtual space, the user feels as if the target T is present far away viewed from the user. Also, when the user approximates the target T to the two view point cameras C1 and C2, the user feels as if the target T is approximated to himself or herself in the real space. Hereinafter, a position in the real space in which the user recognizes that the target T is present is referred to as a recognition position of the target T.

The video display control unit 51 may control display contents so that even if the user changes a direction of a face, the recognition position of the target T in the real space is not changed, or may change the recognition position of the target T in accordance with a change in the direction of the face. In the case of the former, the video display control unit 51 changes the directions of the view point cameras C1 and C2 in accordance with a change in the direction of the face of the user while fixing a position of the target T in the virtual space. Then, the video display control unit 51 generates the image for display indicating an appearance of the interior portion of the virtual space viewed from the respective view point cameras C1 and C2 to be changed. This process permits the user to feel as if the target T is fixed in the real space.

While the video display control unit 51 displays the stereoscopic video including the target T, the position specification unit 52 specifies positions of the hands of the user in the real space by using the photographed image of the stereo camera 43. As described above, the depth map is generated on the basis of the photographed image of the stereo camera 43. The position specification unit 52 specifies, as the hands of the user, an object having a predetermined shape present in a front face (the side near to the user) as compared with other background objects in this depth map.

The operation receiving unit 53 receives an operation to the target T of the user. Particularly, in the present embodiment, movements of the hands of the user are assumed to be received as the operation input. Specifically, the operation receiving unit 53 determines whether or not the user performs the operation to the target T on the basis of a correspondence relation between the positions of the hands of the user specified by the position specification unit 52 and the recognition position of the target T. Hereinafter, the operation to the target T by moving the hands by the user in the real space is referred to as a gesture operation.

Further, in the present embodiment, the operation receiving unit 53 is assumed to receive the gesture operation of the user in two kinds of operation modes different from each other. Hereinafter, the two types of operation modes are referred to as a direct operation mode and an indirect operation mode. The two types of operation modes are different from each other in the correspondence relation between the recognition position of the target T and the positions of the hands of the user in the real space.

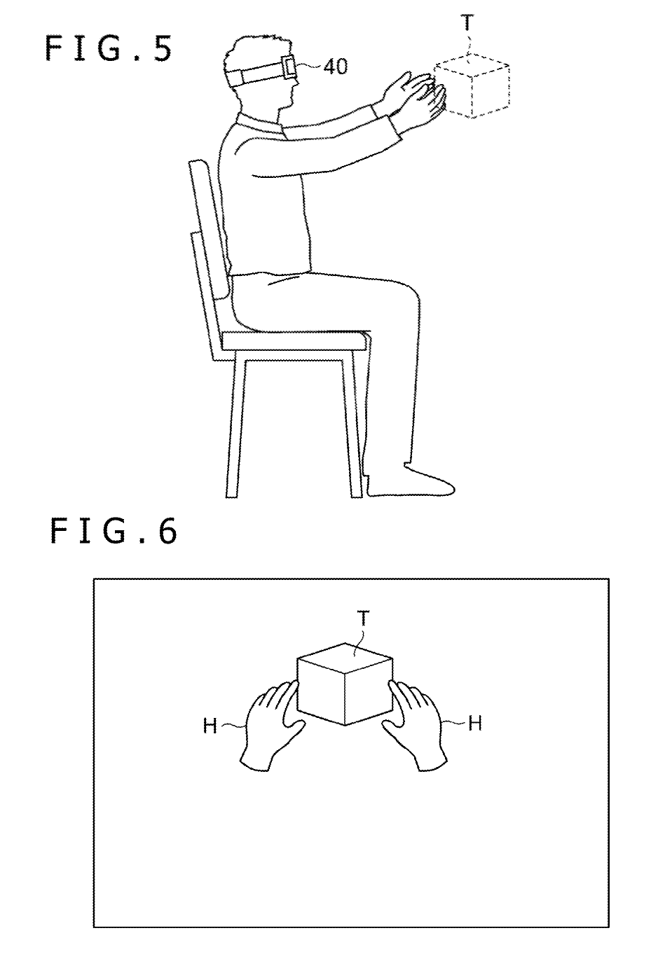

When the positions of the hands of the user in the real space are matched with the recognition position of the target T, the direct operation mode is an operation mode for receiving the gesture operation of the user. FIG. 5 is a diagram illustrating an appearance in which the user performs an operation by using this direct operation mode. In FIG. 5, the recognition position of the target T is illustrated by a broken line. The target T is not present in that recognition position in reality, but the video display control unit 51 generates the stereoscopic video recognized by the user as if the target T is present in that position and allows the video display apparatus 40 to display the stereoscopic video. Then, when the positions of the hands of the user in the real space are directly made to be correspondent to the recognition position of the target T without change and the user moves the hands to the recognition position of the target T, the operation receiving unit 53 determines that the user touches the target T. Through this process, the user can perform the operation to the target T as if the user directly touches the target T that is not present in reality.

More specifically, for example, in the state in which a plurality of targets T are displayed as a selection candidate, the operation receiving unit 53 may determine that the user selects the target T to which the user touches his or her own hands. Further, in accordance with the movements of the hands of the user specified by the operation receiving unit 53, the video display control unit 51 may perform various types of displays such as the target T is moved, or that direction or shape is changed. Further, the operation receiving unit 53 not only simply receives information on the positions of the hands of the user as the operation input but also may specify shapes of the hands at the time when the user moves the hands to the recognition position of the target T and receive the shapes of the hands as the operation input of the user. Through this process, for example, by performing the gesture in which the user moves his or her own hands and grasps the target T, and then moves the hands directly, an operation in which the target T is moved to an arbitrary position or the like can be realized.

FIG. 6 illustrates an example of an image displayed by the video display control unit 51 at the time when the user performs the operation to the target T in the direct operation mode. In the example of this figure, the object H in which the hands of the user are expressed is displayed along with the target T in a position corresponding to the position in the real space specified by the position specification unit 52. The user performs the gesture operation while confirming the object H during this display, and thereby can match his or her own hands with the recognition position of the target T with accuracy.

The indirect operation mode is an operation mode in which the gesture operation the same as the direct operation mode can be performed in another position separated from the recognition position of the target T. In this operation mode, the gesture operation of the user is received on the assumption that the hands of the user are present in a position (hereinafter, referred to as a shifted position) in which the parallel displacement is performed by a predetermined distance in a predetermined direction from a real position in the real space. In accordance with this indirect operation mode, for example, the user puts his or her own hands in a position that is not made tired, such as upper portions of knees and performs the gesture operation the same as the direct operation mode to thereby realize the operation input to the target T.

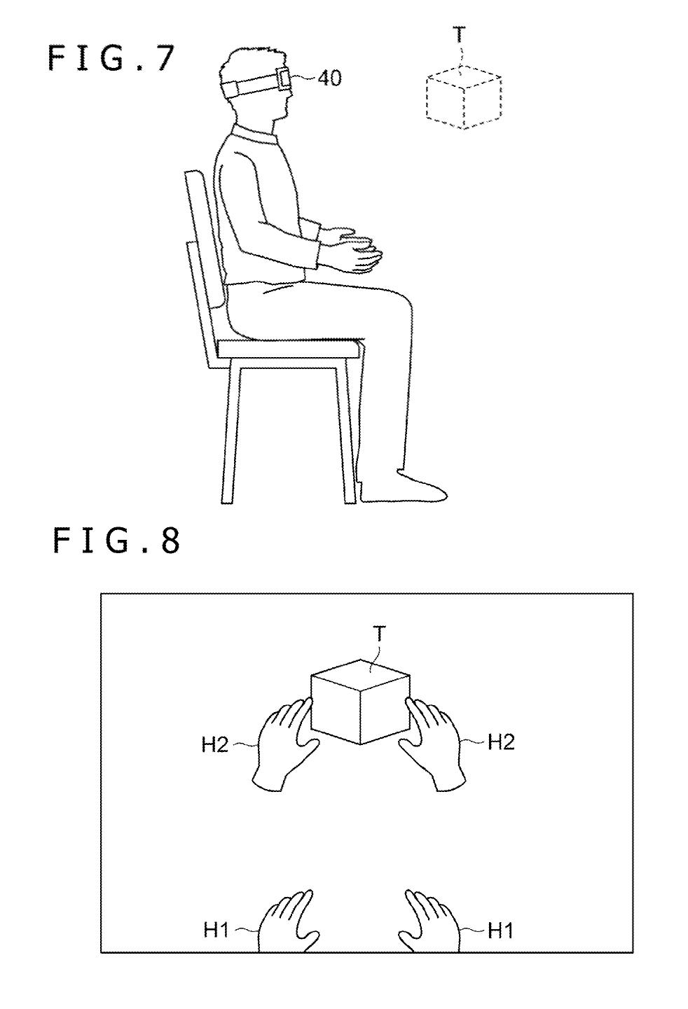

FIG. 7 is a diagram illustrating an appearance in which the user performs an operation by this indirect operation mode. Using as a reference position the positions of the hands of the user at the timing when an operation reception is started in this indirect operation mode, for example, the operation receiving unit 53 determines a shifted direction and a shifted amount to the positions of the hands of the user so that this reference position is approximated to the recognition position of the target T. Then, the operation receiving unit 53 receives the subsequent gesture operations on the assumption that the hands of the user are present in the shifted position in which the parallel displacement is performed by the shifted amount in the shifted direction from the real positions of the hands of the user. Through this process, the user does not purposely move his or her own hands up to the recognition position of the target T and can perform the gesture operation in an attitude in which the user can easily perform an operation.

FIG. 8 illustrates an example of an image displayed by the video display control unit 51 at the time when the user performs the operation to the target T in the indirect operation mode. In the example of this figure, both objects H1 expressing real positions of the hands of the user and objects H2 expressing shifted positions (shifted positions) of the hands of the user are displayed along with the target T. The objects H1 are displayed in positions corresponding to the real positions of the hands of the user specified by the position specification unit 52 in the same manner as in the objects H in FIG. 6. The objects H2 are displayed in a position in which the objects H1 are subjected to the parallel displacement. In addition, the video display control unit 51 may allow the objects H1 and the objects H2 to be displayed in a mode different from each other such as colors of the objects H1 and the objects H2 are changed. By confirming both the objects H1 and the objects H2, the user can perform the gesture operation while viscerally understanding that the positions of his or her own hands are shifted. In addition, the video display control unit 51 does not allow the objects H1 to be displayed and may allow only the objects H2 to be displayed.

From among the above-mentioned plurality of operation modes, the mode switching control unit 54 determines that in which operation mode the operation receiving unit 53 should receive the operation and performs switching of the operation mode. Particularly, in the present embodiment, the mode switching control unit 54 performs the switching from the direct operation mode to the indirect operation mode by using as a trigger that predetermined switching conditions are satisfied. Hereinafter, there will be described a specific example of the switching conditions used as a trigger at the time when the mode switching control unit 54 performs the switching of the operation mode.

First, an example in which a change in an attitude of the user is used as the switching conditions will be described. When the user gets tired during the operation in the direct operation mode, the user is assumed to naturally change his or her own attitude. In order to solve the problems, when the change in the attitude of the user, which is considered to be caused by tiredness, is detected, the mode switching control unit 54 performs the switching from the direct operation mode to the indirect operation mode. Specifically, when the user changes from a leaning forward attitude to an attitude for inclining a body backward such as a weight is put on a chair back, the mode switching control unit 54 performs the switching to the indirect operation mode. On the contrary, when the user changes to the leaning forward attitude during the operation in the indirect operation mode, the mode switching control unit 54 may perform the switching to the direct operation mode. A change in a tilt of the video display apparatus 40 is detected by the motion sensor 44 to thereby specify such a change in the attitude of the user. For example, when an elevation angle of the video display apparatus 40 is a predetermined angle or more, the mode switching control unit 54 is assumed to perform the switching to the indirect operation mode.

Also, the mode switching control unit 54 may switch the operation mode in accordance with whether the user is standing or sitting. The depth map obtained by photography of the stereo camera 43 is analyzed to thereby specify whether the user is standing or sitting. Specifically, since a lowest flat surface present in the depth map is estimated to be a floor face, a distance from the video display apparatus 40 up to the floor face is specified, and thereby it can be estimated that when the specified distance is a predetermined value or more, the user is standing, whereas when the distance is less than the predetermined value, the user is sitting. When the distance up to the floor face is changed from a value of the predetermined value or more to a value less than the predetermined value, the mode switching control unit 54 determines that the user who is standing until then sits down and performs the switching to the indirect operation mode.

Next, an example in which the movements of the hands of the user are used as the switching conditions will be described. When the user interrupts the gesture operation and puts the hands down during the operation in the direct operation mode, the user may get tired. In order to solve the problems, when a motion of putting the hands down by the user (specifically, a motion of moving the hands to a downward position separated by a predetermined distance or more from the target T) is performed, the mode switching control unit 54 may switch the operation mode to the indirect operation mode. Further, when the user puts the hands down once, the operation mode is not immediately switched, and when a state in which the hands are put down is maintained for a predetermined time or more or when a motion of putting the hands down is repeated the predetermined number of times or more, the mode switching control unit 54 may perform the switching to the indirect operation mode.

Also, when it is determined, by analyzing the depth map, that the hands of the user are further approximated to an object that is present below the hands of the user by the determined distance or less, the mode switching control unit 54 may perform the switching to the indirect operation mode. The object that is present below the hands of the user is assumed to be the knees, a desk, or the like of the user. When the user approximates the hands to their objects, the user is thought to put the hands on the knees or the desk. In order to solve the problems, in such a case, the switching is performed to the indirect operation mode, and thereby the user can perform the gesture operation in the state in which the hands are comfortable.

Also, when a motion of putting the operation device 20 held by the hands of the user on the desk or the like is performed, the mode switching control unit 54 may perform the switching of the operation mode. The user may operate the operation device 20 and perform instructions for the information processing apparatus 10, and when releasing control of the operation device 20, it can be determined that the user performs the operation input by the gesture operation subsequently. Therefore, when such a motion is performed, the direct operation mode or the indirect operation mode is assumed to be started. In addition, a motion of putting the operation device 20 by the user can be specified by using the depth map. Further, when the motion sensor is housed in the operation device 20, such a motion of the user may be specified by using the measurement results.

Also, when the user performs a gesture for explicitly instructing the switching of the operation mode, the mode switching control unit 54 may switch the direct operation mode and the indirect operation mode. For example, when the user performs a motion of tapping a particular portion such as his or her own knees, the mode switching control unit 54 may perform the switching of the operation mode. Alternatively, when the user performs a motion of lightly tapping his or her own head, face, the video display apparatus 40, or the like by his or her own hands, the mode switching control unit 54 may switch the operation mode. Such a tap to the head of the user can be specified by using the detection results of the motion sensor 44.

Also, when the user turns over his or her own hands, the mode switching control unit 54 may switch the operation mode to the indirect operation mode. For example, when the user turns over his or her own hands and changes from a state of facing backs of his or her own hands toward the video display apparatus 40 to a state of facing palms of his or her own hands toward the video display apparatus 40, the mode switching control unit 54 switches the operation mode.

Alternatively, the mode switching control unit 54 may transit to a mode of not receiving the operation once at the time when the hands are turned over and switch to another operation mode at the timing when the hands are turned over again therefrom. As a specific example, the operation input using the direct operation mode is assumed to be performed in the state in which the user faces the backs of his or her own hands toward the video display apparatus 40. When the user turns over the hands and faces the palms of the hands toward the video display apparatus 40 from this state, the mode switching control unit 54 temporarily transits to a mode of not receiving the gesture operation of the user. In this state, the user moves his or her own hands to a position in which the gesture operation can be easily performed (on his or her own knees etc.). Afterwards, the user turns over the hands and faces the backs of the hands toward the video display apparatus 40 again. When detecting such movements of the hands, the mode switching control unit 54 switches the operation mode from the direct operation mode to the indirect operation mode. This process permits the user to restart the operation input to the target T in a position in which the hands are turned over.

Also, in addition to the movements of the hands or those (change in the attitude) of the entire body as described above, the mode switching control unit 54 can detect various types of motions of the user and use the above motions as mode switching conditions. For example, when the video display apparatus 40 includes a camera for detecting a line of sight of the user, the mode switching control unit 54 may perform the switching of the operation mode by using videos photographed by that camera. In order to detect a direction of the line of sight of the user, the video display apparatus 40 may include a camera in a position (specifically, a position faced toward the inside of the apparatus) in which both the eyes of the user can be photographed at the time of wearing the video display apparatus 40. The mode switching control unit 54 analyzes photographed images of this camera for detecting the line of sight and specifies movements of the eyes of the user. Then, when the eyes of the user perform the specified movement, the mode switching control unit 54 may switch the operation mode. Specifically, for example, when the user continuously repeats a blink a plurality of times, one eye is closed for the predetermined time or more, both the eyes are closed for the predetermined time or more, or the like, the mode switching control unit 54 is assumed to switch the operation mode. Through this process, the user does not perform a relatively large motion such as the hands are moved, and can instruct the information processing apparatus 10 to switch the operation mode.

Also, the mode switching control unit 54 may use voice information such as voices of the user as conditions of the mode switching. In this case, a microphone is disposed in a position in which voices of the user can be collected and the information processing apparatus 10 is assumed to acquire voice signals collected by this microphone. In addition, the microphone may be housed in the video display apparatus 40. In this example, the mode switching control unit 54 executes voice recognition processing with respect to the acquired voice signals or the like and specifies speech contents of the user. Then, when it is determined that the user speaks voices to instruct switching of the operation mode such as a “normal mode” or a “on-the-knee mode,” or particular contents such as “tired,” the mode switching control unit 54 performs the switching to the operation mode set in accordance with the speech contents.

Also, when a particular kind of sound is detected from the voice signals, the mode switching control unit 54 may perform the switching to a particular operation mode. For example, when detecting voices such as a sigh, yawn, cough, harrumph, sneeze, clicking, applause, or finger snap of the user, the mode switching control unit 54 may switch the operation mode.

Also, when the predetermined time has elapsed, the mode switching control unit 54 may switch the operation mode. As a specific example, when the predetermined time has elapsed from the start of the direct operation mode, the mode switching control unit 54 may perform the switching to the indirect operation mode.

Further, when any of the above-described switching conditions are satisfied, the mode switching control unit 54 does not immediately perform the switching of the operation mode and may switch the operation mode after making confirmation of intention of the user. For example, when the elapse of the above-mentioned predetermined time is set as the switching conditions, the mode switching control unit 54 inquires of the user whether or not the switching of the operation mode is performed by menu display or voice reproduction at the time when the predetermined time has elapsed. The user responds to this inquiry by using the speeches, the movements of the hands, or the like, and thereby the mode switching control unit 54 performs the switching of the operation mode. Through this process, the operation mode can be set so as not to be switched despite intentions of the user.

In accordance with the above-described information processing apparatus 10 according to the present embodiment, the gesture operation can be performed in a place separated from the recognition position of the target T displayed as the stereoscopic video, and therefore the user can perform the gesture operation in his or her easier attitude. Further, the direct operation mode in which the hands are directly moved in the recognition position of the target T and the indirect operation mode in which the hands are moved in a separated place are switched under various types of conditions, and thereby the gesture operation can be performed in a desirable mode for the user.

In addition, the embodiment of the present invention is not limited to the above-described embodiment. For example, in the above descriptions, the movements of the hands of the user are specified by using the stereo camera 43 disposed in the front face of the video display apparatus 40, however, not limited thereto, and the information processing apparatus 10 may specify the movements of the hands of the user by using a camera or sensor installed in other positions. For example, when the user performs the gesture operation on the knees etc., in order to detect the movements of the hands of the user with high accuracy, a stereo camera different from the stereo camera 43 may be further fixed in a position capable of photographing the lower side of the video display apparatus 40. Also, the movements of the hands of the user may be detected by using not the video display apparatus 40 but the camera or sensor installed in another place.

### REFERENCE SIGNS LIST

1 Video display system, 10 Information processing apparatus, 11 Control unit, 12 Storage unit, 13 Interface unit, 30 Relay device, 40 Video display apparatus, 41 Video display device, 42 Optical device, 43 Stereo camera, 44 Motion sensor, 45 Communication interface, 51 Video display control unit, 52 Position specification unit, 53 Operation receiving unit, 54 Mode switching control unit

1. An information processing apparatus connected to a video display apparatus worn on a head and used by a user, comprising:
a video display control unit configured to allow the video display apparatus to display a stereoscopic video including an object to be operated;
a specification unit configured to specify a position of a hand of the user in a real space;
an operation receiving unit configured to receive a gesture operation to the object by moving the hand by the user in a first operation mode when there is a match between a recognition position in which the user recognizes that the object is present in the real space and a shifted position deviated from the specified position of the hand by a predetermined amount, and receive the gesture operation in a second operation mode different from the first operation mode when there is a match between the recognition position and the specified position of the hand; and
a switching control unit configured to perform switching from the second operation mode to the first operation mode when detecting a predetermined change in an attitude of the user.

2. (canceled)

3. (canceled)

4. The information processing apparatus according to claim 1, wherein
the switching control unit specifies a direction of the video display apparatus and thereby detects the predetermined change in the attitude.

5. The information processing apparatus according to claim 1, wherein
when a predetermined movement of the hand of the user is detected, the switching control unit performs switching from the second operation mode to the first operation mode.

6. The information processing apparatus according to claim 5, wherein
the switching control unit detects as the predetermined movement a motion of putting the hand down by the user.

7. The information processing apparatus according to claim 5, wherein
the switching control unit detects as the predetermined movement a motion of turning over the hand by the user.

8. The information processing apparatus according to claim 1, wherein
when a predetermined voice uttered by the user is detected, the switching control unit switches the first operation mode and the second operation mode.

9. An information processing method comprising:
allowing a video display apparatus worn on a head and used by a user to display a stereoscopic video including an object to be operated;
specifying a position of a hand of the user in a real space;
receiving a gesture operation to the object by moving the hand by the user in a first operation mode when there is a match between a recognition position in which the user recognizes that the object is present in the real space and a shifted position deviated from the specified position of the hand by a predetermined amount, and receiving the gesture operation in a second operation mode different from the first operation mode when there is a match between the recognition position and the specified position of the hand; and
performing switching from the second operation mode to the first operation mode when detecting a predetermined change in an attitude of the user.

10. A program for a computer connected to a video display apparatus worn on a head and used by a user, comprising:
by a video display control unit, allowing the video display apparatus to display a stereoscopic video including an object to be operated;
by a specification unit, specifying a position of a hand of the user in a real space;
by an operation receiving unit, receiving a gesture operation to the object by moving the hand by the user in a first operation mode when there is a match between a recognition position in which the user recognizes that the object is present in the real space and a shifted position deviated from the specified position of the hand by a predetermined amount, and receiving the gesture operation in a second operation mode different from the first operation mode when there is a match between the recognition position and the specified position of the hand; and
by a switching control unit, performing switching from the second operation mode to the first operation mode when detecting a predetermined change in an attitude of the user.
